(19) United States
(12) Patent Application Publication
(10) Pub. No.: US 2006/0290694 A1
(43) Pub. Date: Dec. 28, 2006

(54) Local reconstruction of a tetrahedral grid

(75) Inventors: Popov Igor Victorovich, Moscow (RU); Polyakov Sergey Vladimirovich, Moscow (RU); Valeriy Sukharev, Cupertino, CA (US)

Correspondence Address: LSI LOGIC CORPORATION, 1621 BARBER LANE, MS: D-106, MILPITAS, CA, 95035, US

(73) Assignee: LSI Logic Corporation

(21) Appl. No.: 11/165,013

(22) Filed: Jun. 23, 2005

(51) Int. Cl. G06T 17/00

(52) U.S. Cl. 345/420

(57) ABSTRACT

A method of local reconstructing a grid containing a plurality of adjoining tetrahedrals wherein spheres cannot be constructed around each tetrahedral without including a vertex of another tetrahedral into a grid containing the tetrahedrals wherein spheres can be constructed around each tetrahedral without including a vertex of another tetrahedral. In the method, a face which adjoins two of the tetrahedrals is removed, thereby defining a hexahedron. If four vertices of the hexahedron are not on the same plane, an edge is constructed from a vertex of one tetrahedral to a vertex of another tetrahedral, such that three faces are defined inside the hexahedron, and such that the hexahedron is divided into three tetrahedrals, wherein spheres can be constructed around each tetrahedral without including a vertex of another tetrahedral. If four vertices of the hexahedron are on the same plane, a modified approach is used.

### BACKGROUND

The present invention generally relates to grids which contain tetrahedrals, and more specifically relates to methods for local reconstructing such grids to meet what is referred to as the Delauney criterion, wherein spheres can be circumscribed around each tetrahedral without containing any vertices of the other tetrahedrals.

The Delauney criterion concerns rules for mesh generation and specifically provides that, in a two-dimensional grid, triangles be defined such that circles can be circumscribed around each triangle without enclosing a vertex from another triangle. This provides a more simple analysis, such as in the case of a finite element method (FEM).

Perhaps the most complete description of results obtained in this field may be found in the book “Mesh generation. Application to finite elements.”, Eds. P. J. Frey, P. L. George, Hermes Science Publishing, Oxford, UK (http://www.hermes-science.com). In chapter seven of this book, there is a survey of algorithms based on the Delauney criterion known at that time. In the book, it is proposed that the minimal number of tetrahedrals used for self-reconstruction equals four or more, which is not consistent with the Delauney criterion, from a two-dimensional standpoint (when the number of triangles used for self-reconstruction equals two).

The present invention proposes to reconstruct a tetrahedral grid by using only two tetrahedrals, such that spheres can be circumscribed around each tetrahedral without containing any vertices of the other tetrahedrals, which is consistent with the Delauney criterion as applied to two-dimensions.

The present invention provides optimization which can be used in association with a finite element method (FEM). FEM's are often used in circuit design and allow a user to simulate a real failure development in the realistic interconnect segments under action of electrical stressing. A complexity of the problem that should be analyzed can be measured by the degree of freedom (DOF) parameter, which depends on the amount of variables and the amount of finite elements. In semiconductor design, the DOF can easily reach the level of tens of millions, which is huge. This is a problem which does not allow standard simulation tools to be employed to predict electromagnetic-induced (EM-induced) degradation. One of the most important problems which must be overcome to develop software which is capable of simulating EM-induced degradation is to minimize the amount of finite elements needed to accurately represent the problem. This minimization should also work to improve simulation time and bring it to a reasonable value. One of the possibilities to minimize the amount of finite elements lies in the optimization of the subdomain partitioning into finite elements. The present invention is an example of such an optimization, specifically with regard to tetrahedral grids. The present invention can be employed for the solution of a wide range of problems, characterized by the large number of DOF. For example, many problems related to the FEM-based analysis of stress, temperature, fracture, etc. in microelectronics subjects can be solved faster by implementing the present invention.

### OBJECTS AND SUMMARY

An object of an embodiment of the present invention is to provide a method of local reconstructing a tetrahedral grid, using only two adjacent tetrahedrals.

Another object of an embodiment of the present invention is to provide a method of local reconstructing a tetrahedral grid, consistent with the Delauney criterion, wherein spheres can be circumscribed around each tetrahedral without containing any vertices of the other tetrahedrals.

Briefly, and in accordance with at least one of the foregoing objects, an embodiment of the present invention provides a method of reconstructing a grid containing a plurality of adjoining tetrahedrals wherein spheres cannot be constructed around each tetrahedral without including a vertex of another tetrahedral into a grid containing the tetrahedrals wherein spheres can be constructed around each tetrahedral without including a vertex of another tetrahedral. The method includes the steps of removing a face which adjoins two of the tetrahedrals, thereby defining a hexahedron, and determining if four vertices of the hexahedron are on the same plane. If it is determined that four vertices of the hexahedron are not on the same plane, the following steps are performed: constructing an edge from a vertex of one tetrahedral to a vertex of another tetrahedral, such that three faces are defined inside the hexahedron, and such that the hexahedron is divided into three tetrahedrals, wherein spheres can be constructed around each tetrahedral without including a vertex of another tetrahedral. However, if it is determined that four vertices of the hexahedron are on the same plane, the following steps are performed: constructing an edge from a vertex of one tetrahedral to a vertex of another tetrahedral, determining a point at which the edge which has been constructed intersects an original edge of the hexahedron, constructing an edge from the point of intersection to a vertex of the hexahedron, such that two faces are defined inside the hexahedron, and such that the hexahedron is divided into four tetrahedrals, wherein spheres can be constructed around each tetrahedral without including a vertex of another tetrahedral. If it is determined that four vertices of the hexahedron are on the same plane and there are two other tetrahedrals such that each of them has three of these vertices as their own vertices, in this case both tetrahedrals have to be reconstructed in the same way as the two original ones.

### BRIEF DESCRIPTION OF THE DRAWINGS

The organization and manner of the structure and operation of the invention, together with further objects and advantages thereof, may best be understood by reference to the following description, taken in connection with the accompanying drawing, wherein:

FIG. 1 illustrates a method which can be implemented to reconstruct a tetrahedral grid, wherein the method is in accordance with an embodiment of the present invention;

FIG. 2 illustrates a tetrahedral grid wherein four vertices are not in the same plane;

FIG. 3 shows the grid of FIG. 2, as reconstructed using the method of FIG. 1;

FIG. 4 illustrates a tetrahedral grid, wherein four vertices are in the same plane; and

FIGS. 5 and 6 show the grid of FIG. 4, as reconstructed using the method of FIG. 1.

### DESCRIPTION

While the invention may be susceptible to embodiment in different forms, there are shown in the drawings, and herein will be described in detail, specific embodiments of the invention. The present disclosure is to be considered an example of the principles of the invention, and is not intended to limit the invention to that which is illustrated and described herein.

The present invention provides a method of local reconstructing a tetrahedral grid, using only two adjacent tetrahedrals. The resulting grid is consistent with the Delauney criterion, and provides that spheres can be circumscribed around each tetrahedral without containing any vertices of the other tetrahedrals.

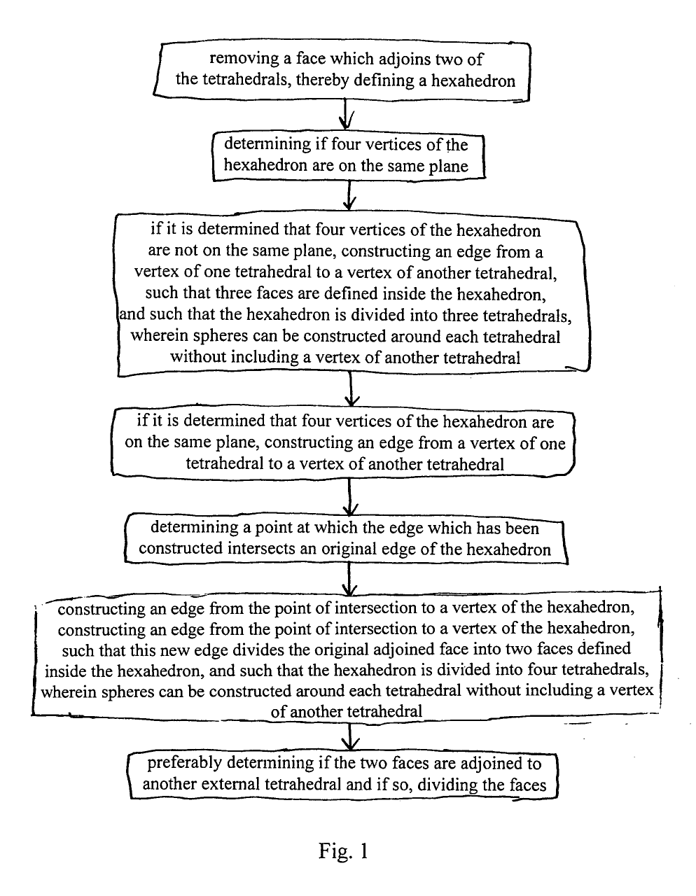

FIG. 1 illustrates a method which can be implemented to reconstruct a tetrahedral grid, wherein the method is in accordance with an embodiment of the present invention. The method is a method of local reconstructing a grid containing a plurality of adjoining tetrahedrals wherein spheres cannot be constructed around each tetrahedral without including a vertex of another tetrahedral into a grid containing the tetrahedrals wherein spheres can be constructed around each tetrahedral without including a vertex of another tetrahedral. The steps of the method will be described with reference to the subsequent Figures.

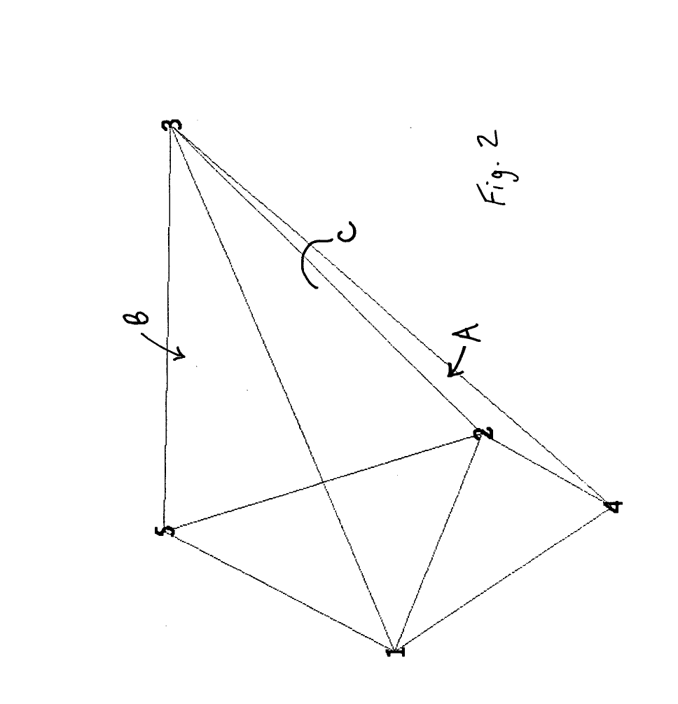

With reference to FIG. 2, consider two tetrahedrals A, B having a common face C (defined by vertices 1, 2, 3). If a sphere were to be circumscribed around one of the tetrahedrals (for example, tetrahedral A having vertices 1, 2, 3, 4), the non-common vertex (5) of the other tetrahedral (tetrahedral B having vertices 1, 2, 3, 5) would be inside the sphere. Because the vertex (5) of the other tetrahedral (tetrahedral B having vertices 1, 2, 3, 5) would be included in the sphere circumscribed around tetrahedral A (having vertices 1, 2, 3, 4), the approach is not consistent with the Delaunay criterion. A method in accordance with the present invention provides for the reconstruction of such a tetrahedral grid, such that the resulting grid is consistent with the Delauney criterion, and provides that spheres can be circumscribed around each tetrahedral without containing any vertices of the other tetrahedrals.

As shown in FIG. 1, and with reference to FIG. 2, the method provides that face C (defined by vertices 1, 2, 3) between the two tetrahedrals is removed, thereby defining a hexahedron D (with vertices 1, 2, 3, 4, 5 in FIG. 2). As shown in FIG. 2, the volume and form of this hexahedron D are the same as both of the original two tetrahedrals A and B.

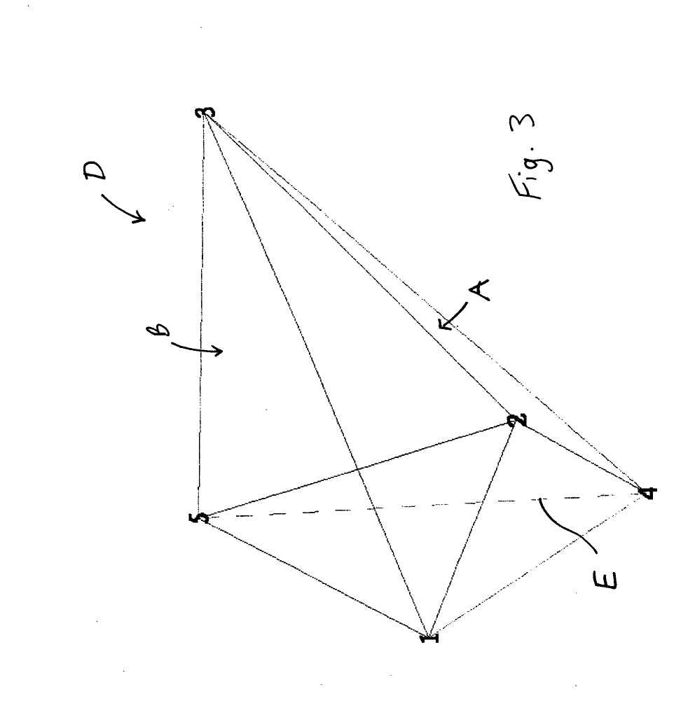

FIG. 2 illustrates an example where four vertices (1, 2, 4, 5 in FIG. 2) are not on the same plane. In such a case, as shown in FIG. 3, an edge E is constructed from a vertex (4) of one tetrahedral (tetrahedral A) to a vertex (5) of another tetrahedral (tetrahedral B), such that three faces (one face with vertices 1, 4, 5; one face with vertices 2, 4, 5; and one face with vertices 3, 4, 5) are defined inside the hexahedron D, dividing this hexahedron into three tetrahedrals (one tetrahedral with vertices 1, 2, 4, 5; one tetrahedral with vertices 2, 3, 4, 5; and one tetrahedral with vertices 3, 1, 4, 5). The resulting tetrahedrals are defined such that spheres can be circumscribed around each new tetrahedral without including a vertex of another tetrahedral. For example, in the example shown in FIG. 3, a sphere can be circumscribed around tetrahedral 1, 2, 4, 5 while avoiding vertex 3; a sphere can be circumscribed around tetrahedral 2, 3, 4, 5 while avoiding vertex 1; and a sphere can be circumscribed around tetrahedral 3, 1, 4, 5 while avoiding vertex 2. As such, analysis and use of the tetrahedral grid can be simplified.

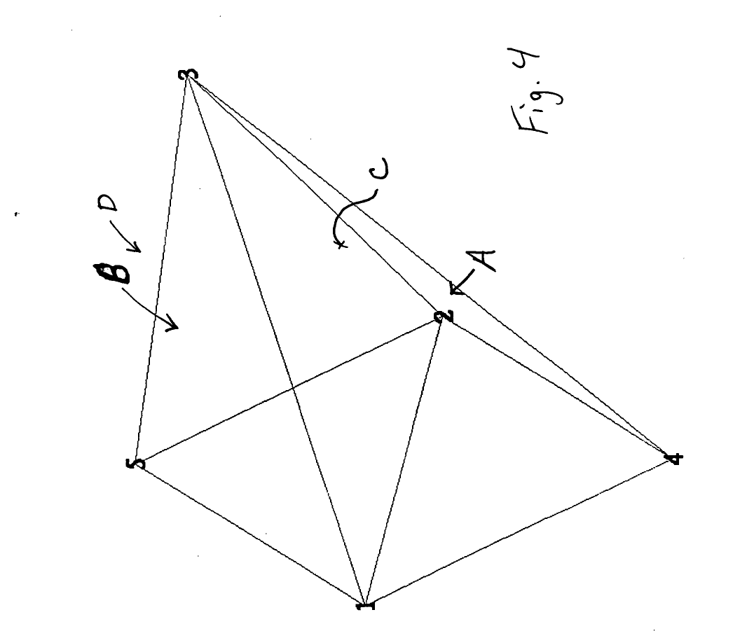

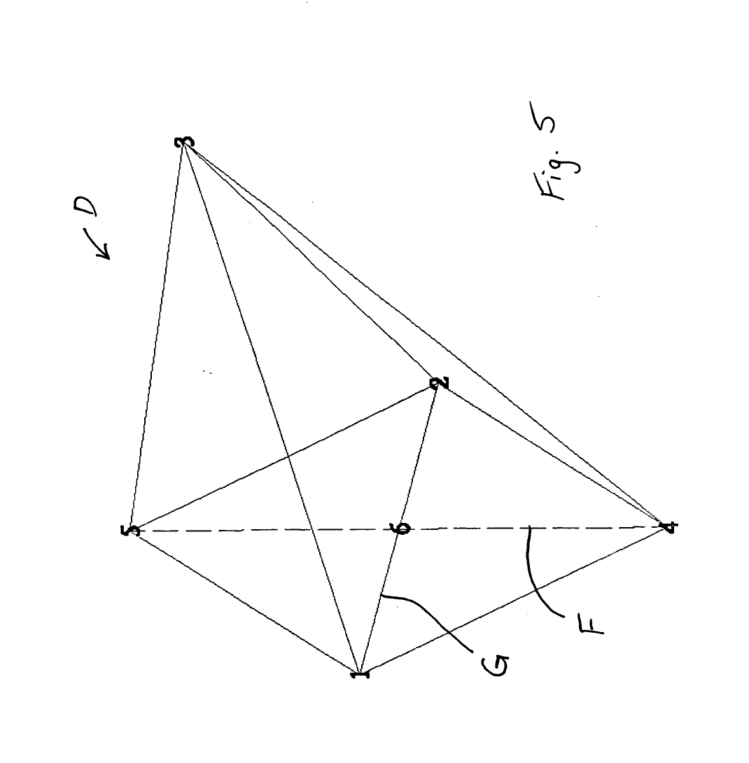

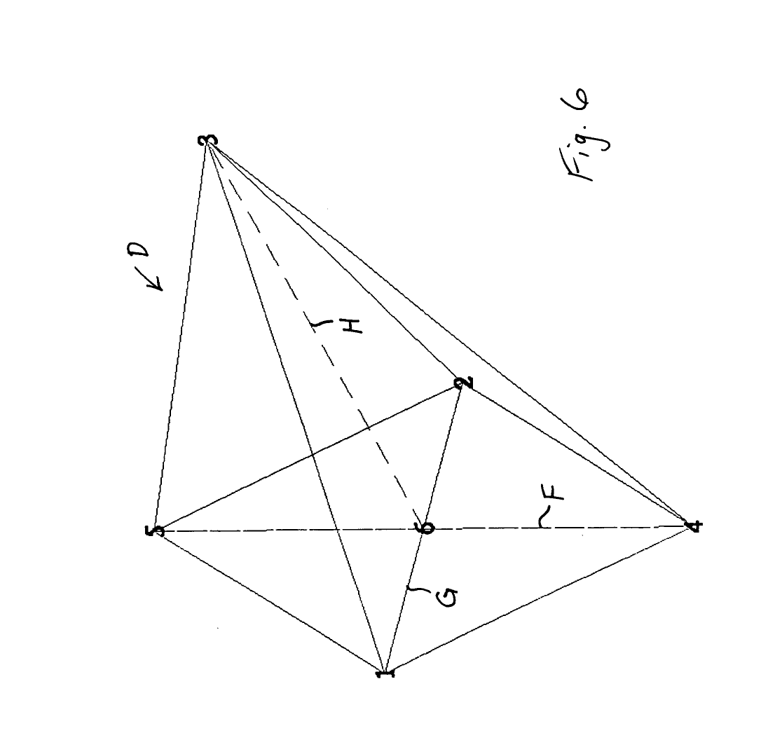

FIG. 4 illustrates a tetrahedral grid similar to that which is shown in FIG. 2, but illustrates an example where four vertices (1, 2, 4, 5 of FIG. 4) of the hexahedron D are on the same plane. In such a case, as shown in FIGS. 1 and 5, after removing the face C having vertices (1, 2, 3 in FIG. 4) between the two tetrahedrals, thereby defining a hexahedron D (with vertices 1, 2, 3, 4, 5 in FIG. 4), an edge F is constructed from a vertex (4) of one tetrahedral to a vertex (5) of another tetrahedral (see FIGS. 1 and 5), and a point at which the edge which has been constructed intersects the original edge G (defined by vertices 1, 2 in FIG. 5) of the hexahedron D is determined (the point of intersection is identified with reference numeral 6 in FIG. 5). Then, as shown in FIGS. 1 and 6, an edge H is constructed from the point of intersection (6) to a vertex (3) of the hexahedron D, such that two faces (the face with vertices 6, 3, 4 in FIG. 6; and a face with vertices 6, 3, 5 in FIG. 6) are defined inside the hexahedron D, such that the hexahedron D is divided into four tetrahedrals (one tetrahedral having vertices 1, 6, 3, 4; one tetrahedral having vertices 2, 6, 3, 4; one tetrahedral having vertices 1, 6, 3, 5; and one tetrahedral having vertices 2, 6, 3, 5), wherein spheres can be constructed around each tetrahedral without including a vertex of another tetrahedral. As shown in FIG. 1, preferably if faces (1, 2, 4) and (1, 2, 5) (see FIG. 4) are adjoined to some other external tetrahedrals, preferably they are divided in the same way.

The present invention provides a method of local reconstructing a tetrahedral grid, using only two adjacent tetrahedrals. The resulting grid is consistent with the Delauney criterion, and provides that spheres can be circumscribed around each tetrahedral without containing any vertices of the other tetrahedrals. As such, use and analysis of the tetrahedral grid can be simplified, as used in connection with, for example, a finite element method (FEM).

While embodiments of the present invention are shown and described, it is envisioned that those skilled in the art may devise various modifications of the present invention without departing from the spirit and scope of the appended claims.

What is claimed is:

1. A method of local reconstructing a grid containing a plurality of adjoining tetrahedrals wherein spheres cannot be constructed around each tetrahedral without including a vertex of another tetrahedral into a grid containing the tetrahedrals wherein spheres can be constructed around each tetrahedral without including a vertex of another tetrahedral, said method comprising: removing a face which adjoins two of the tetrahedrals, thereby defining a hexahedron; constructing an edge from a vertex of one tetrahedral to a vertex of another tetrahedral, such that three faces are defined inside the hexahedron, and such that the hexahedron is divided into three tetrahedrals, wherein spheres can be constructed around each tetrahedral without including a vertex of another tetrahedral.

2. A method of local reconstructing a grid containing a plurality of adjoining tetrahedrals wherein spheres cannot be constructed around each tetrahedral without including a vertex of another tetrahedral into a grid containing the tetrahedrals wherein spheres can be constructed around each tetrahedral without including a vertex of another tetrahedral, said method comprising: removing a face which adjoins two of the tetrahedrals, thereby defining a hexahedron; constructing an edge from a vertex of one tetrahedral to a vertex of another tetrahedral; determining a point at which the edge which has been constructed intersects an original edge of the hexahedron; constructing an edge from the point of intersection to a vertex of the hexahedron, such that this new edge divides the original adjoined face into two faces defined inside the hexahedron, and such that the hexahedron is divided into four tetrahedrals, wherein spheres can be constructed around each tetrahedral without including a vertex of another tetrahedral.

3. A method as recited in claim 2, further comprising determining if the two faces are adjoined to another external tetrahedral and if so, dividing the faces.

4. A method of local reconstructing a grid containing a plurality of adjoining tetrahedrals wherein spheres cannot be constructed around each tetrahedral without including a vertex of another tetrahedral into a grid containing the tetrahedrals wherein spheres can be constructed around each tetrahedral without including a vertex of another tetrahedral, said method comprising: removing a face which adjoins two of the tetrahedrals, thereby defining a hexahedron; determining if four vertices of the hexahedron are on the same plane;
if it is determined that four vertices of the hexahedron are not on the same plane, performing the following steps:
constructing an edge from a vertex of one tetrahedral to a vertex of another tetrahedral, such that three faces are defined inside the hexahedron, and such that the hexahedron is divided into three tetrahedrals, wherein spheres can be constructed around each tetrahedral without including a vertex of another tetrahedral;
if it is determined that four vertices of the hexahedron are on the same plane, performing the following steps:
constructing an edge from a vertex of one tetrahedral to a vertex of another tetrahedral; determining a point at which the edge which has been constructed intersects an original edge of the hexahedron;
constructing an edge from the point of intersection to a vertex of the hexahedron, constructing an edge from the point of intersection to a vertex of the hexahedron, such that this new edge divides the original adjoined face into two faces defined inside the hexahedron, and such that the hexahedron is divided into four tetrahedrals, wherein spheres can be constructed around each tetrahedral without including a vertex of another tetrahedral.

5. A method as recited in claim 4, wherein if it is determined that four vertices of the hexahedron are on the same plane, performing the additional following steps: determining if the two faces are adjoined to another external tetrahedral and if so, dividing the faces.
